(19) United States
(12) Patent Application Publication
(10) Pub. No.: US 2025/0012239 A1
(43) Pub. Date: Jan. 9, 2025

(54) HEATED THROTTLE PLATE

(71) Applicant: Weaver Intellectual Property, LLC, Jupiter, FL (US)

(72) Inventors: Ronald J. Weaver, Jupiter, FL (US); Chad Szwarnowicz, Jupiter, FL (US)

(21) Appl. No.: 18/763,354

(22) Filed: Jul. 3, 2024

Related U.S. Application Data
(60) Provisional application No. 63/512,303, filed on Jul. 7, 2023.

(51) Int. Cl. F02M 15/04; F16K 49/00

(52) U.S. Cl. CPC F02M 15/04; F16K 49/002

(57) ABSTRACT

A heated throttle plate formed from a strip of etched 304SS foil rated for 35 watts and formed into a predetermined pattern having a first end electrically coupled to a positive leadwire and a second end electrical coupled to a ground leadwire. The foil is positioned between layers of polyimide for encapsulating the foil therebetween. The leadwires are electrically coupled to a fused relay connection secured to an engine oil pressure sensor. In one embodiment the heater plate operates on 14 volts and 35 watts for heating the throttle valve to 150° F. A throttle shaft forms a channel for passage of the leadwires through the throttle body housing. The heater plate is constructed and arranged to conform to the shape of a stock throttle valve and attach thereto utilizing stock throttle valve fasteners.

### PRIORITY CLAIM

In accordance with 37 C. F. R. § 1.76, a claim of priority is included in an Application Data Sheet filed concurrently herewith. Accordingly, the present invention claims priority to U.S. Provisional Patent Application No. 63/512,303, entitled “Heated Throttle Plate”, filed Jul. 7, 2023. The above referenced application is incorporated herein by reference.

### FIELD OF THE INVENTION

This invention is directed to the field of general aviation carburetors and, in particular, to a heated throttle plate.

### BACKGROUND OF THE INVENTION

Carburetor icing affects internal combustion engines operating under a large range of atmospheric conditions. Carburetor icing is caused by a fuel vaporization temperature drop associated with the pressure drop in the carburetor venturi. In order for the fuel to change from a liquid state to a gaseous state, heat must be taken from the air and added to the fuel, thus cooling the air. The venturi is used to change the fuel state and can drop the ambient air temperature by 70° F. When the temperature is lowered below freezing, water vapor can freeze on the throttle valve and internal surfaces of the carburetor.

For example, if the outside air temperature is 100° F., air passing through the venturi can drop 70 degrees wherein ice formation is probable. Carburetor icing is most common when the outside air temperature is below 70° F. and the relative humidity is above 80 percent. If enough moisture is in the air (generally above 50% humidity) ice will form. This can create a condition that feeds on itself. As ice builds on the throttle valve it creates more of a venturi dropping the temperature even more.

Carburetor icing that occurs in general aviation aircraft can lead to deadly consequences unless the pilot anticipates the problem and immediately addresses the situation. Unfortunately, a pilot may not recognize an icing situation on a nice sunny day. Should icing occur and the pilot is unprepared, the result can be an unplanned off-field landing, or worse. Most every carbureted airplane includes a method of introducing heat into a carburetor. A manually operated control typically marked as “Carb Heat” is found within the cockpit. The control is a mechanical connection used to divert hot air, typically from the exhaust manifold, into the carburetor for melting or preventing ice formation. Icing can develop while idling on the ground, long before the exhaust manifold is warmed up. Also, a problem with introducing hot air into the carburetor is that heated air will make the mixture richer which decreases the engine power. A reduction in power can also lead to catastrophic results should a go-around be necessary and the aircraft is filled with fuel and passengers.

In a helicopter, applying carburetor heat during approach to a hover, even partial heat, can prevent the pilot from obtaining hover power, due to the rich mixture, which at a minimum could result in an unintentional hard landing. Conventional teaching is for a helicopter pilot to apply full carburetor heat before initiating the approach descent to “heat soak” the carburetor, then a few hundred feet prior to touchdown turn off the carburetor heat, or leave a small amount, as the power comes into the hover and the throttle keeps opening.

General aviation fixed wing aircraft and helicopters may employ a “constant speed” prop wherein a governor maintains a constant RPM. This constant RPM can mask the formation of carburetor icing as the governor keeps opening the throttle to counter the ice blockage. Failure to maintain proper rotor RPM is the leading cause of fatal accidents in helicopters. When the engine stops due to carburetor icing, the pilot has mere seconds to decrease the pitch of the rotor blades before stalling and entering an unrecoverable dive. Even if the pilot recognizes a low RPM situation with the engine still operating, lowering the collective (decreasing the pitch) also closes the throttle valve, which can lead to an immediate choking of the engine due to ice. Similarly the pilot of a fixed wing aircraft must anticipate or recognize icing conditions during various phases of a flight to avoid loss of power. Without sufficient power to the propeller, the aircraft must return to the ground.

While various s attempts have been made to address carburetor icing in both the automotive industry and aviation industry, what works in the automotive industry may not work in aviation. Aviation engines require 100% power at critical times; seldom does an automotive engine require full power. Aviation must deal with changes in altitude which amount to 3.5° F. change for each 1000 feet of elevation, which is especially problematic when an aircraft descends over 1000 feet per minute. While carburetor heat is the conventional method of addressing carburetor icing, the application and timing of heat introduction requires proper pilot training.

Carburetor icing is a well known problem that dates back over 100 years. U.S. Pat. No. 1,422,896 which issued in 1922 discloses a heating coil for carburetors positioned in the path of the spray of fuel from the carburetor suction nozzle.

U.S. Pat. No. 3,916,859 discloses a carburetor anti-icing system in which hot or warm oil is passed through a passageway disposed through the shaft of the carburetor throttle valve thereby warming the valve and preventing icing on the valve and also cooling the oil passing through the shaft.

U.S. Pat. No. 5,209,211 discloses an integrated heating device in an axial bore of the throttle valve shaft. The power supply to the heating device is by means of regulating circuit in an electronic control unit which is connected to the heating device by a conductor.

U.S. Pat. No. 7,364,139 discloses a carburetor having a throttle valve in the form of a disc which can be rotated to control flow of an air/fuel mixture through a duct, the throttle disc having a heating element and a temperature sensor formed on at least one surface of said throttle disc; and an electric power supply, the electric power supply being controlled by a temperature sensor, to maintain the temperature of the throttle disc above a predetermined minimum temperature. The temperature response time of the order of 10 ms and a resolution of the order of 0.01° C.

U.S. Pat. No. 8,113,169 discloses a heating element for heating a throttle valve of an automobile engine. Specifically, a controller receives an output signal from an air flow sensor, and when a quantity of intake air is equal to or less than a predetermined “intake air quantity criterion for heating”, conduction of electricity to the heating element is carried out. Conversely, when the quantity of intake air is greater than this “intake air quantity criterion for heating”, conduction of electricity to the heating element 4 is prohibited.

U.S. Patent 10,738, 713 discloses a throttle valve abnormality determination device that includes a first temperature acquisition unit configured to acquire a first temperature that is a temperature in a passage through which intake air flows, a second temperature acquisition unit configured to acquire a second temperature that is a temperature in the passage, an air amount acquisition unit configured to acquire an intake air amount that is a mass flow rate of the intake air, and a permission/rejection determination unit configured to determine whether or not to permit a sticking determination of a throttle valve based on the first temperature, the second temperature, and the intake air amount.

U.S. Patent Publication 2004/0182370 discloses an electrically heated throttle body. The throttle assembly includes a throttle body housing having a heating element integrally formed in the housing. During the manufacturing process, the heating element is formed into a predetermined shape and held in an appropriate position within a mold used to form the housing. The heating element is encased by the throttle housing material.

### SUMMARY OF THE INVENTION

Disclosed is a heating plate for use with an engine mounted aircraft carburetor employing a rotatable throttle valve. The plate is formed from a strip of etched 304SS foil rated for 35 watts and formed into a predetermined pattern having a first end electrically coupled to a positive leadwire and a second end electrical coupled to a ground leadwire. The foil is positioned between an upper layer of polyimide and a lower layer of polyimide and attached thereto by silicone adhesive for encapsulating the foil therebetween. The heater plate is then attached to the throttle valve with an adhesive, the throttle valve and heater plate are then attached to the throttle shaft using the stock throttle valve fasteners. The leadwires are electrically coupled to a fused relay connection secured to an engine oil pressure sensor providing 14 volts and 35 watts for heating the throttle valve to 150° F. when the oil pressure sensor detects engine oil pressure. A throttle shaft forms a channel for passage of the leadwires, the channel having an elliptical side wall to shield the leadwires during shaft rotation. The heater plate is constructed and arranged to conform to the shape of a stock throttle valve and attach thereto utilizing stock throttle valve fasteners.

An objective of the invention is to simplify the electronics and operation of applying carburetor heat by disclosing a plate which provide constant heat to the throttle valve at a rate not to exceed 150° F. to prevent seed ice from forming.

Still another objective of the invention is to disclose that under most conditions, ice does not have a change to form if the throttle plate is kept warm during idle and take-off. Preventing ice from forming at low engine power setting eliminates seed for the ice to form from. Ice would only form under extreme conditions wherein conventional carburetor heat can be employed.

Another objective of the invention is to supplement the conventional use of Carb Heat, wherein Carb Heat is employed by a pilot in all conditions that may cause carburetor icing.

Still another objective of the invention is to avoid any adverse effect on the flow of the fuel-air mixture by use of a plate that adds 0.015 inches to the throttle valve.

Yet still another objective of the invention is to provide an carburetor heater installation that can be achieved with minimal expense and requires no modification to an existing carburetor housing. The advantage is the ability to quickly replace the components and the low cost heating element can be attached to a stock throttle valve. The only modification is a throttle valve shaft wherein a channel allows power wires to be connected through the throttle body housing.

Still another objective of the invention is to provide a modification wherein the fuel-air mixture flow is not affected by routing of heater wires through the throttle shaft, and use of a heating plate secures to a stock throttle plate employing the same fasteners.

Still another objective of the invention is to provide a carburetor heater wherein the flow around the throttle valve is virtually unimpeded.

Yet still another objective of the invention is teach a throttle valve heating plate that only draws 35 watts, which is an insignificant current draw for general aviation aircraft.

Other objectives and further advantages and benefits associated with this invention will be apparent to those skilled in the art from the description, examples, and claims which follow.

### BRIEF DESCRIPTION OF THE DRAWINGS

FIG. 1 is a front perspective view of the general aviation carburetor with the heater plate;

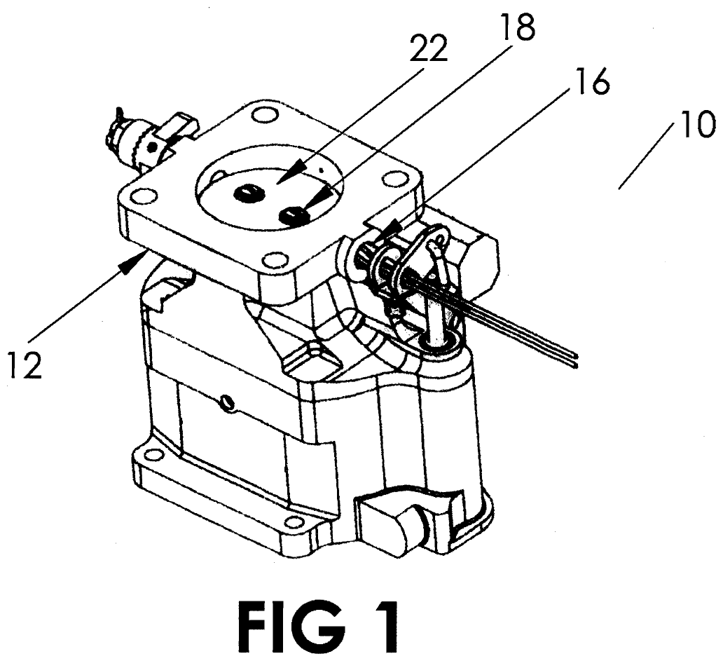

FIG. 2 is a front perspective view illustrating the heater plate in an exploded view;

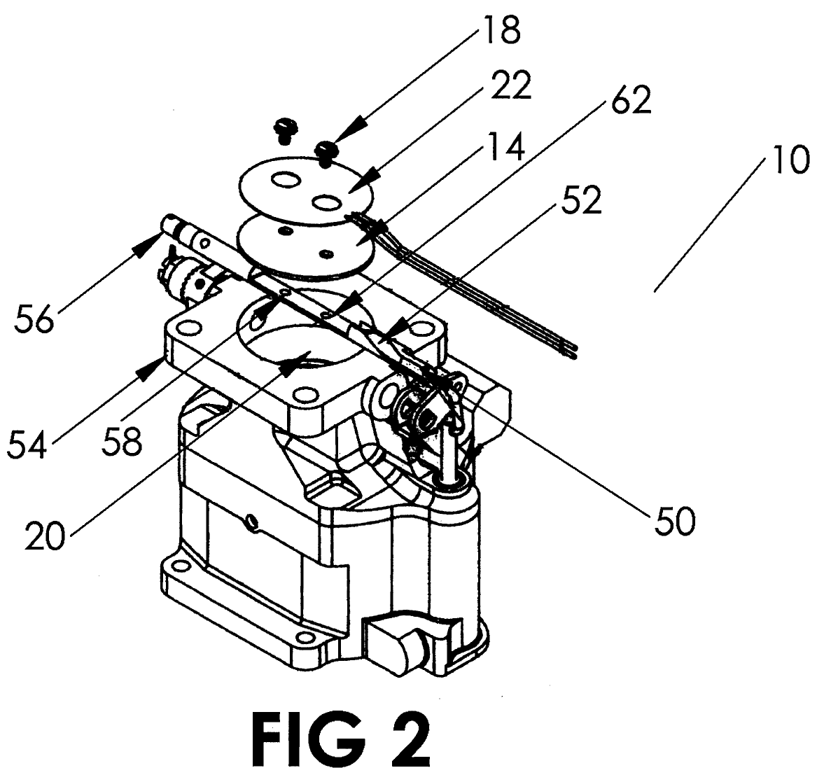

FIG. 3 is a side perspective view thereof;

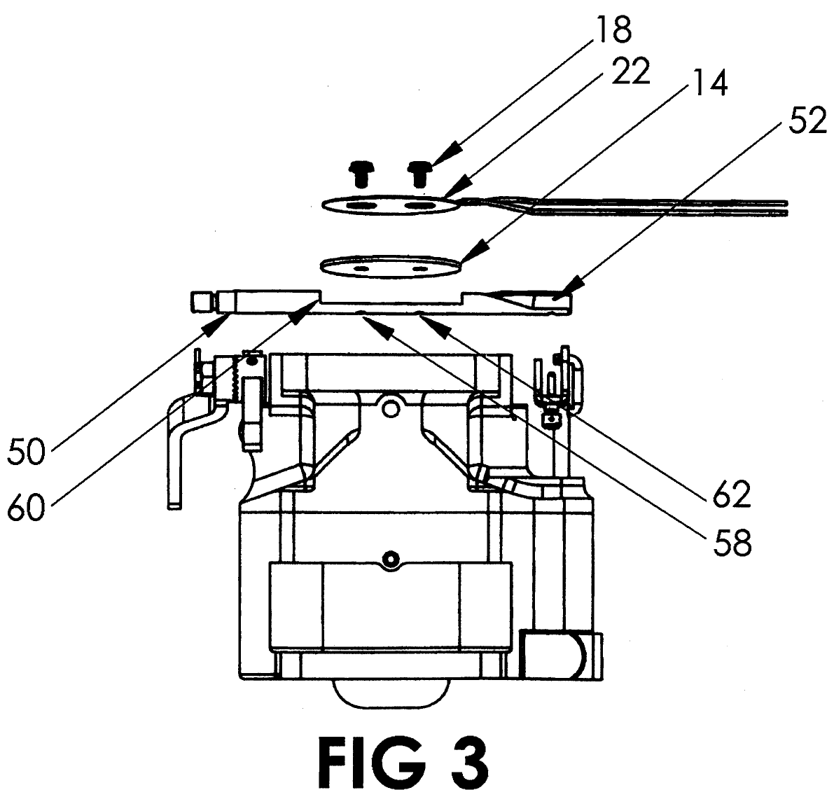

FIG. 4 is a top plane view of the heater plate;

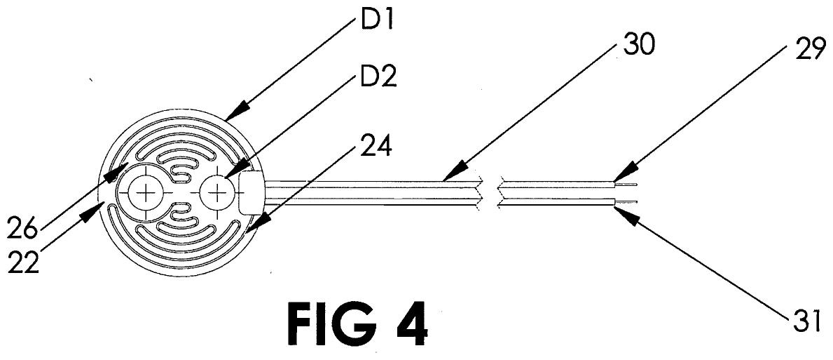

FIG. 5 is a cross sectional side view of the heater plate; and

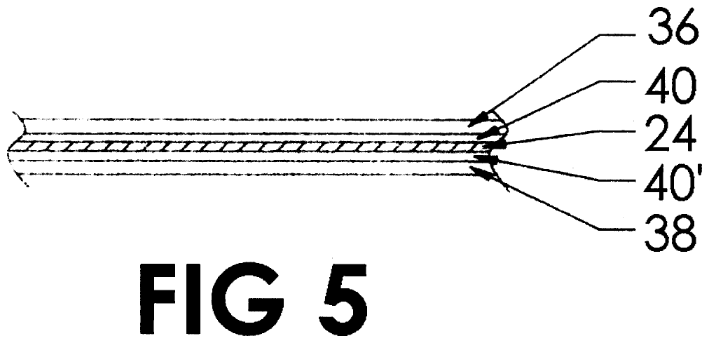

FIG. 6 is a top plane view of the heater plate with temperature sensor.

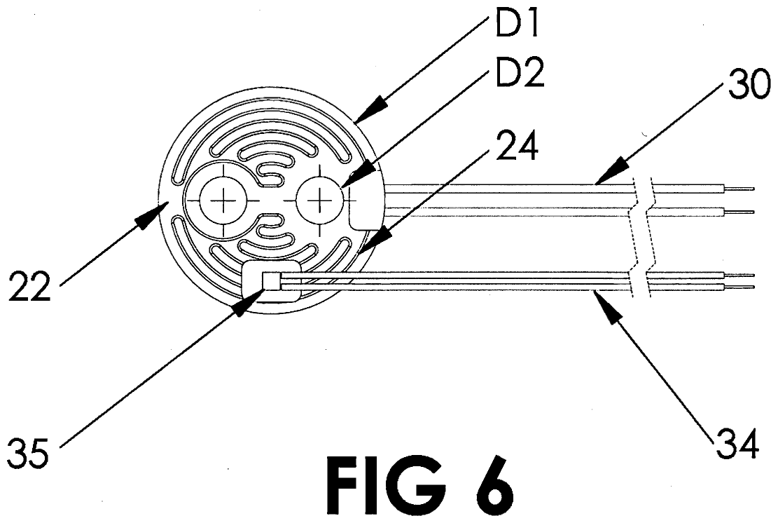

### DETAILED DESCRIPTION OF THE PREFERRED EMBODIMENT

A detailed embodiment of the instant invention is disclosed herein. Specific functional and structural details disclosed herein are not to be interpreted as limiting, but merely as a basis for the claims and as a representation basis for teaching one skilled in the art to variously employ the present invention in virtually any appropriately detailed structure. The carburetor depicted in this disclosure is for illustration purposes only. There are numerous carburetor shapes, all of which use throttle valves. It will be understood by one skilled in the art that the adaptation of the disclosed heated plate to other carburetors is deemed within the scope of this invention.

Referring to the Figures, depicted is a carburetor 10 having a throttle body assembly 12 with a throttle valve 14 attached to throttle shaft 16 by fasteners 18. The throttle valve 14 is positioned along the venturi 20 which causes air pressure to be dropped for use in converting liquid fuel into vapor, in accordance with Bernoulli's principle. The carburetor's operation depends on the differential pressure caused by the venturi 20 effect.

The heated throttle plate 22 is formed from a strip of etched 304SS foil 24 rated for 35 watts and formed into a predetermined pattern 26 electrically coupled to leadwires 30 for power to the foil 24. The foil 24 is positioned between an upper layer 36 of polyimide and a lower layer 38 of polyimide and attached thereto by silicone adhesive 40, 40′ for encapsulating the foil 24 therebetween. The heater plate 22 is constructed and arranged to conform to the shape of the stock throttle valve 14 and attach thereto utilizing stock throttle valve fasteners 18. The etched foil 24 is constructed and designed to operate at 35 watts to produce a constant heat to the throttle valve 14 at a rate not to exceed 150° F. while the engine is operating. The heated throttle plate 22 would operate at all times the engine oil sensor detects the engine is running. By operating continuously, ice does not have an opportunity to seed so as to allow an accumulation of ice. Drawing only 35 watts, the alternator is not taxed allowing continuation operation. Further, since the operation is continuous, a pilot need not be further trained on the operation as it is automatic. The instant invention does not replace conventional Carburetor heat devices and is used to supplement current Carb Heat devices. The instant invention provides an additional safety factor by providing throttle plate heating at all times.

The heating plate leadwires 30 formed from a positive connector 29 and a negative connector 31 are electrically coupled to a fused relay connection, not shown, which would be secured to an engine oil pressure sensor. The fused relay connection providing 14 volts and 35 watts when an oil pressure sensor detects engine oil pressure, or 24 volts with a comparable wattage. In one embodiment the heater plate 22 has a diameter D1 of 48.3 mm with mounting apertures having a diameter D2 of 10.2 mm, spaced apart by a length L of 20.7 mm. The voltage, current, and dimensions provided are for illustration only; it will be understood by one skilled in the art that the voltage may be 28 volts wherein the 70 watts could be provided, or that the dimensions vary to accommodate for various sized throttle plates. In one embodiment the heater plate 22 leadwires 30 are 26 gauge, leadwires 34 for an optional temperature sensor 35 are also 26 gauge. A platinum resistance temperature sensor 35 can be secured to the heating plate 22 by adhesive to collect data on the plate's surface temperature.

A modified throttle shaft 50 forming a channel 52 allows passage of the leadwires 30, and if sensor equipped, leadwires 34 through the housing 54. The channel 54 having an open side entry 56 protects the leadwires from chafing during normal operation of the throttle valve. The open side entry allows ease of assembly and visual inspection. The throttle shaft 50 is a direct replacement in all other aspects to a conventional stock throttle shaft. Threaded receptacles 58 and 62 receive the fasteners 18. It is noted that the recessed surface 60 allow placement of the plate 18 to be in-line with the modified throttle shaft 50 to maintain the leadwires 30, 34 in line with the channel 52.

The plate 22 provides a constant heat to the throttle valve 14 at a rate not to exceed 150° F. while the engine is operating to prevent seed ice from forming. Testing revealed that ice does not have a chance to form if the throttle plate is kept warm during idle and take-off. Preventing ice from forming at low engine power setting then there is no seed for the ice to form from. Ice could still form under extreme conditions wherein conventional Carburetor heat can be employed.

The term “about” means, in general, the stated value plus or minus 5%. The term “coupled” is defined as connected, although not necessarily directly, and not necessarily mechanically. The use of the word “a” or “an” when used in conjunction with the term “comprising” in the claims and/or the specification may mean “one,” but it is also consistent with the meaning of “one or more” or “at least one.” The use of the term “or” in the claims is used to mean “and/or” unless explicitly indicated to refer to alternatives only or the alternative are mutually exclusive, although the disclosure supports a definition that refers to only alternatives and “and/or.”

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements, possesses those one or more steps or elements, but is not limited to possessing only those one or more elements. Likewise, a step of a method or an element of a device that “comprises,” “has,” “includes” or “contains” one or more features, possesses those one or more features, but is not limited to possessing only those one or more features.

Furthermore, a device or structure that is configured in a certain way is configured in at least that way, but may also be configured in ways that are not listed.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A heated throttle plate for use with an engine mounted aircraft carburetor employing a rotatable throttle valve, said heated throttle plate comprising:
a plate formed from a strip of etched foil formed into a predetermined pattern having a first end electrically coupled to a positive leadwire and a second end electrical coupled to a negative leadwire, said heater plate constructed and arranged to conform to the shape of a throttle valve and attach thereto with adhesive;
a throttle shaft coupled to said throttle valve having a channel for passage of said leadwires;
a power source electrically coupled to said leadwires;
wherein said plate is constructed and arranged to heat said throttle valve at a rate not to exceed 150° F. while the engine is operating.

2. The heated throttle plate according to claim 1 wherein said foil is positioned between an upper layer of polyimide and a lower layer of polyimide and attached thereto by silicone adhesive for encapsulating said foil therebetween.

3. The heated throttle plate according to claim 2 wherein heated throttle plate has a thickness of about 0.015 inches.

4. The heated throttle plate according to claim 1 wherein power source is a fused relay connection secured to an engine oil pressure sensor, said fused relay connection providing power when an oil pressure sensor detects engine oil pressure.

5. The heated throttle plate according to claim 1 including a resistance temperature sensor secured to the heating plate to collect data on the plate's surface temperature.

6. The heated throttle plate according to claim 1 wherein said etched foil is constructed from 304SS.

7. The heated throttle plate according to claim 1 wherein said channel includes an elliptical side wall to shield the leadwires during shaft rotation.

8. The heated throttle plate according to claim 1 wherein said foil is rated at 35 watts using 14 volts.

9. The heated throttle plate according to claim 1 wherein said foil is rated at 70 watts using 28 volts.
